(19) United States
(12) Patent Application Publication
(10) Pub. No.: US 2004/0167914 A1
(43) Pub. Date: Aug. 26, 2004

(54) Information processing device with network automatic duplicating function and method thereof

(76) Inventor: Kun-Ta Tsai, Taipei (TW)

Correspondence Address: J.C. Patents, Inc., 4 Venture, Suite 250, Irvine, CA, 92618, US

(21) Appl. No.: 10/779,112

(22) Filed: Feb. 12, 2004

(30) Foreign Application Priority Data
Feb. 25, 2003 (TW) 92103873

(51) Int. Cl. G06F 17/00

(52) U.S. Cl. 707/100

(57) ABSTRACT

An information processing device including a network automatic duplicating function and a method thereof is provided. A network automatic duplicating unit is used to check whether there is a file that will be recorded into a data storage unit. A corresponding message is sent to a message queue in sequence while there is the file that will be recorded into a data storage unit. Then, the file is duplicated automatically to one or some network storage devices assigned by a duplication configuration file via a network interface. The information processing device uses a user interface to configure the duplication configuration file according to the requirement, so it is easy to configure and the files that will be recorded into a data storage unit can be duplicated automatically to one or some network storage devices in real time.

### CROSS-REFERENCE TO RELATED APPLICATION

This application claims the priority benefit of Taiwan application serial no. 92103873, filed on Feb. 25, 2003.

### BACKGROUND OF THE INVENTION

1. Field of Invention

The present invention generally relates to an information processing device, and more particularly, to an information processing device with a network automatic duplicating function and a method thereof.

2. Description of Related Art

Because of the great progress of electronic technology, various computer and information digital equipment have become increasingly accepted. The information processing devices such as computers and server systems have been developed for different applying fields. To achieve the object of sharing resource, a network system is generally used to interconnect the information processing device and various network storage devices. Moreover, when there is any file oriented in the information processing device with the need of recordation or modification, the corresponding file stored in the network storage device has to be updated, simultaneously, so as to remain data accuracy.

Conventionally, there are three different types of the file update for the information processing device. The first type is each network storage device actively checks and duplicates the file of the information processing device. However, this method has following problems:

1. The network storage device would take its processing time for the duplication, that is, each network storage device has to continuously check whether there is any file that needs to be duplicated. This operation takes CPU processing time of the network storage device and accordingly degrades performance of all network storage devices.

2. The configuration is rather complicated. Each network storage device needs to be configured individually if a several network storage devices are intended to be duplicated, simultaneously.

3. The system is rather complicated. Besides the information processing device, the whole system further comprises a plurality of data duplication centers formed by the network storage devices, resulting in complication of the system.

The second type implements remote replication with a network storage device. However, this method has the following problems:

1. The configuration is complicated. Multiple sessions need to be configured for duplicating to a network storage device, so as to barely achieve the duplication function in real time. If duplicating to multiple network storage devices simultaneously is required, then configuring multiple sessions repeatedly is inevitable.

2. It does not support the real time duplication function. When there is a file waiting for recordation or to be modified, the duplication operation is not started until the session of the remote duplication configured by the user is reached.

3. Since the information processing device cannot directly control it, each network storage device has to install software for controlling it.

Another type is using the FAIL-OVER high-level network device. This method has following problems:

1. The network storage device has to use the block duplication, thus its design is very complicated.

2. Only one network storage device can be used to duplicate each time.

3. It only supports full duplication. Partial duplication is not supported due to its lacking flexibility.

### SUMMARY OF THE INVENTION

To solve the problem mentioned above, an information processing device with a network automatic duplicating function and a method thereof are provided by a preferred embodiment according to the present invention. It permits the user to conveniently configure the required duplication rules. Accordingly, at least one selected file for recordation into the information storage unit of the information processing device are able to be automatically duplicated to at least one predetermined network storage devices in real time. Meanwhile, either a part or full file can be predetermined in the duplication rules, and duplication to either one or more specified network storage devices also can be selected, simultaneously.

To achieve the mentioned object and others, the present invention provides an information processing device with a network automatic duplicating function. Besides comprising a network automatic duplicating unit, the information processing device further comprises a data storage unit, a user interface, and an information processing unit. Meanwhile, the data storage unit can store at least a file for recordation of the information processing unit. The user interface allows the user to configure a required duplication rule via the information processing device, and saves the duplication rule to a duplication configuration file located in the network automatic duplicating unit. The network automatic duplicating unit is respectively coupled to the data storage unit and the information processing unit. The network automatic duplicating unit is used to check whether there is any file for recordation in the information processing unit. While there is any file found for writing in the data storage unit, the file will be duplicated via the network interface to the network storage device specified by the duplication rule recorded in the duplication configuration file.

According to the preferred embodiment of the present invention, the network automatic duplicating unit further comprises: a file checking subunit, a message generating subunit, a message queuing subunit, a message checking subunit, and a file duplicating subunit. Meanwhile, the file checking subunit can check the aforementioned file in real time to determines whether there is any file to be recorded or modified. The message generating subunit can create a corresponding file variation message as long as the file checking subunit finds at least a file to be recorded or modified. The message queuing subunit is used for receiving of the file variation message, and sequentially stores the file variation message into a message queue. The message checking subunit sequentially checks whether there is any file variation message found in the message queue or not. The file duplicating subunit duplicates the file for recordation via the network interface to at least one network storage devices specified by the duplication configuration file, according to the file variation message and the duplication configuration file mentioned above.

According to a preferred embodiment, said file variation message comprises at least a duplicated file path and a duplicated file name.

However, in the embodiment, if the file name or the file path recorded in the file variation message can not be correspondingly found in the configuration of the duplication configuration file or the corresponding network storage device is not one configured in the duplication configuration file, the file duplicating unit will automatically duplicate the file to a predetermined network storage device via the network interface, so as to ensure a file backup. Said network interface is as an Ethernet interface.

In the embodiment, the user can selectively configure the required duplication configuration file which will be stored in the network automatic duplicating unit, via the user interface.

In the embodiment, the information processing device is an information product as one of the hand-held/desktop/server computer, mobile phone, or PDA (Personal Digital Assistant) devices.

The present invention further provides a network automatic duplicating method for automatically duplicating at least a file oriented from the information processing device. The network automatic duplicating method comprises the steps of: at first, monitoring variation of any one specified file which is being processed in the information processing device in real time; determining whether there is any file generated by the information processing device for recordation; creating a corresponding file variation message when it is found that the variation of the file occurs in the information processing device; storing the file variation message into a message queue; continuously checking whether there is any file variation message found in the message queue; and duplicating said file via a network interface to the corresponding network storage device specified by a duplication configuration file, according to the found file variation message and the duplication configuration file.

Meanwhile, the file variation message at least comprises a duplicated file path and a duplicated file name. If the file name or the file path recorded by the file variation message is not correspondingly found in the configuration of the duplication configuration file or the corresponding network storage device is not one configured in the duplication configuration file, the file for recordation will be then duplicated to a fixed and predetermined network storage device via the network interface such as an Ethernet interface.

Said duplication configuration file can be selectively configured, via the user interface of the information processing device, upon user's requirement. Optionally, the network automatic duplicating method further comprises a step of clearing the file variation message existing in the message queue.

It is known as mentioned above, in the information processing device provided by the present invention, a network automatic duplicating unit is capable to check whether there is any file to be written in the data storage unit in real time. As long as there is any file found for writing, the found file will be correspondingly duplicated to the network storage device specified by a duplication rule via the network interface, according to the duplication configuration file. And, each duplication rule recorded in the duplication configuration file is easy to be pre-configured by the user with a user interface. Furthermore, the user interface provides that the duplication of either part of or full file can be selected, and duplicating to either one or multiple network storage devices simultaneously can be selected.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a block diagram and a system connection diagram of an information processing device of the preferred embodiment according to the present invention.

FIG. 2 schematically shows a block diagram of a network automatic duplicating unit of the information processing device of the preferred embodiment according to the present invention.

FIG. 3 schematically shows a flow chart of a network automatic duplicating method of the preferred embodiment according to the present invention.

### DESCRIPTION OF THE PREFERRED EMBODIMENTS

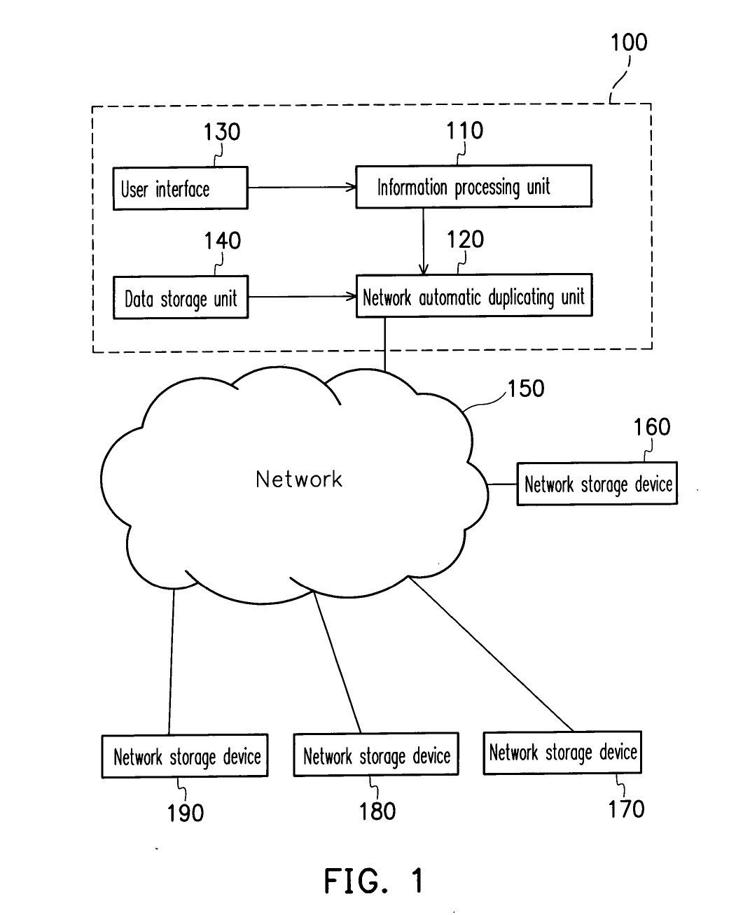

Firstly referring to FIG. 1, it schematically shows a block diagram of an information processing device cooperating with several network storage devices, according to a preferred embodiment of the present invention. The information processing device 100 can be an information appliance (IA) such as one of the hand-held/desktop/server computer, mobile phone, or PDA types.

As shown in FIG. 1, the information processing device 100 and a plurality of network storage devices 160, 170, 180, and 190 are connected with each other via a network 150 such as an Ethernet. Perfectly, the network storage devices 160, 170, 180, and 190 may be a Network Attachment Storage (NAS). The information processing device 100 shown in FIG. 1 includes a user interface 130, an information processing unit 110, a network automatic duplicating unit 120, and a data storage unit 140 (e.g. hard disk). Said information processing unit 110 may be a CPU or a system with CPU function.

Meanwhile, said data storage unit 140 is used to access files oriented from the information processing device 100 for recordation of data. The user interface 130 is a window style user interface for conveniently guiding a user to pre-configure the required duplication rule and then saving the duplication rule to a duplication configuration file located in the network automatic duplicating unit 120 while it is necessary for the user to back up some specified files of the information processing device 100 to the desired network storage device. Therefore, the backup of the files between the data storage unit 140 and each network storage device 160, 170, 180, and 190 can be properly managed as desired by means of this convenient user interface. Each time the data storage unit 140 prepares for accepting the file written by the user, the information processing device 100 can automatically duplicate the file to the specified network storage device 160, 170, 180, or 190 in advance based on user's predetermined configuration in real time. Thus, the consistence between the source and backup of the data can be permanently remained.

As shown in FIG. 1, the network automatic duplicating unit 120 respectively couples to the data storage unit 140 and the information processing unit 11O thereby monitoring the variation of the specified files which may be stored in the data storage unit 140 or oriented from the data processing unit 110, so as to determine whether there is any file written or modified into the data storage unit 140 in real time. When there is a file found for recordation, the file will be correspondingly duplicated to the network storage device 160, 170, 180, or 190 specified by the duplication configuration file via a network interface of the connected network 150, according to the duplication rule recorded in the duplication configuration file of the network automatic duplicating unit 120, so as to update the corresponding file previously stored in the network storage device 160, 170, 180, or 190.

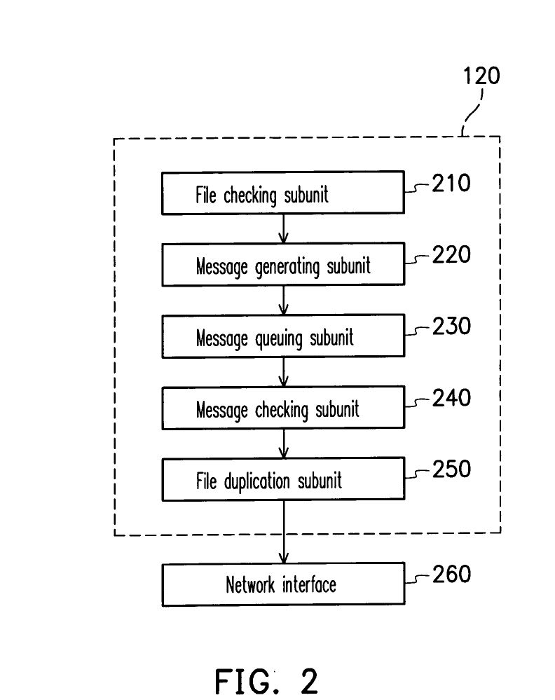

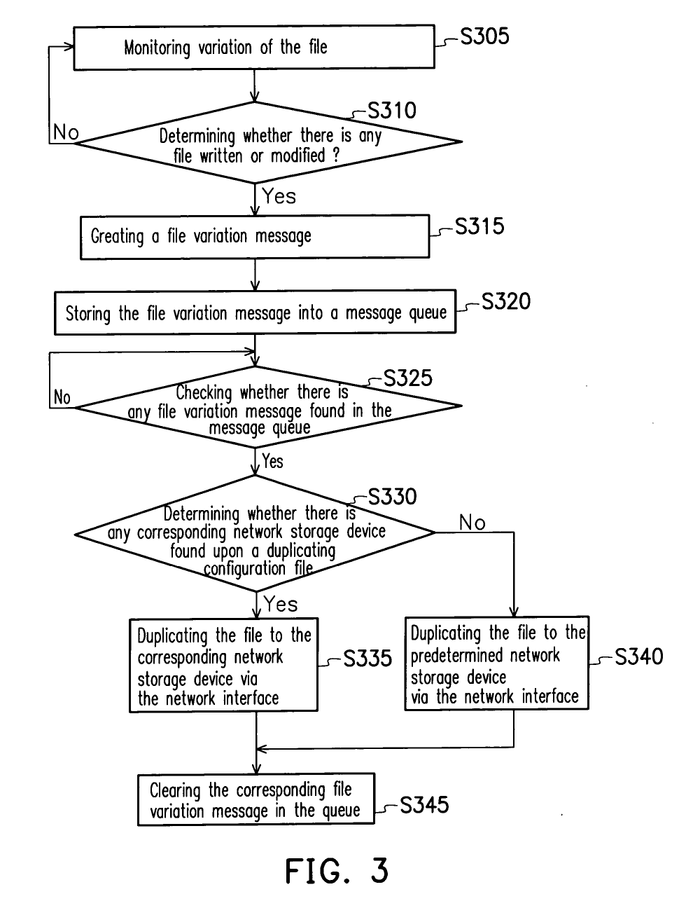

Please referring to both FIG. 2 and FIG. 3, wherein FIG. 2 schematically shows a block diagram of a network automatic duplicating unit 120 in the information processing device 100 according to the preferred embodiment of the present invention, and FIG. 3 schematically shows a flow chart of a network automatic duplicating method according to the preferred embodiment of the present invention.

As shown in FIG. 2, the network automatic duplicating unit 120 comprises a file checking subunit 210, a message generating subunit 220, a message queuing subunit 230, a message checking subunit 240, and a file duplicating subunit 250. Its operating principle is described in detail referring to the flow chart in FIG. 3 hereinafter.

At first, the network automatic duplicating unit 120 uses the file checking subunit 210 to monitor the variation of some specified files which are being stored into the data storage unit 140 or being proceeded by the data processing unit 110 (S305), so as to determine whether there is any file being written into the data storage unit 140 or modified in real time (S310).

As long as the file checking subunit 210 finds any file which is being written in or modified, the message generating subunit 220 is facilitated to correspondingly create a corresponding file variation message (S315). Meanwhile, the format of the file variation message records path and name of at least a duplicated file. Certainly, it will be obvious to one of the ordinary skill in the same art that the serial number for identifying the sequence of the file variation message also can be inserted in front of the duplicated file path and the duplicated file name.

The message queuing subunit 230 receives the file variation message created by the message generating subunit 220, and then stores the received file variation message into a message queue in sequence (S320) for the reference of subsequently duplicating file to the network storage device 160, 170, 180, or 190.

The message checking subunit 240 is used to check whether there is any file variation messages found in the message queue (S325). Each time an earliest file variation message is found in the message queue, the file duplicating subunit 250 refers to the duplication configuration file pre-stored by the user, so as to determine whether the name or the path of the file to be recorded and is recorded by the file variation message that appears in the configuration of the duplication configuration file or not, and determine whether any corresponding network storage device exists in the duplication configuration file or not (S330). Further, several duplication rules can be configured in the duplication configuration file mentioned above by the user via the user interface 130 in FIG. 1. Wherein, each duplication rule comprises a plurality of parameters, such as the name of the file (or the so-called source file) to be duplicated, the path of the file to be duplicated, the network storage device of the duplicated destination, the name of the destination file and the path of the destination file, and the style or direction of the duplication, such as duplicating to multiple network storage devices simultaneously, or duplicating to different network storage device in sequence. Therefore, its configuration operation is quite simple.

When the file duplicating subunit 250 determines a network storage device corresponding to the name or path of the file to be recorded and is recorded by the file variation message is found in the duplication configuration file, the file is duplicated to the corresponding network storage device via the network interface 260 such as the Ethernet (S335). Otherwise, when the file duplicating subunit 250 determines the name or path of the file to be recorded and is recorded by the file variation message is not found in the configuration of the duplication configuration file, or determines that the corresponding network storage device is not configured in the duplication configuration file, the file is duplicated to another fixed and predetermined network storage device 160 via the network interface 260 (S340), so as to ensure the file to be recorded in the information processing device 100 has a backup copy in the network storage device. After step S340 and S335 are completed, the corresponding file variation message in the message queue is automatically cleared (S345).

In summary, the present invention at least has following advantages.

1. The present invention can automatically duplicate file in real time, that is, when there is a file to be recorded into the data storage unit of the data processing device, the file is automatically duplicated to one or some specified network storage devices in real time.

2. Its operation is quite simple. The user interface of the information processing device can be used to configure the duplication rule, so as to selectively configure the network storage device of the destination.

3. The present invention can be optionally selected to duplicate the partial file or full file.

4. The present invention can be optionally selected to duplicate file to one network storage device or duplicate file to multiple network storage devices simultaneously.

Although the invention has been described with reference to a particular embodiment thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1. A network automatic duplicating unit suitable for automatically duplicating at least a file oriented from an information processing device to at least one network storage device, comprising:
a file checking subunit used to monitor variation of the file in the information processing device thereby determining whether there is any file generated by the information processing device for recordation;
a message generating subunit used to create a corresponding file variation message when the file checking subunit finds out variation of the file in the information processing device;
a message queuing subunit used to receive the file variation message thereby storing the file variation message into a message queue;
a message checking subunit, used to check whether there is any file variation message found in the message queue; and
a file duplicating subunit in accordance with the file variation message found by the message checking subunit, duplicating the file via a network interface to at least one network storage devices specified by a duplication configuration file.

2. The network automatic duplicating unit of claim 1, wherein the file variation message consists of at least a duplicated file path and a duplicated file name.

3. The network automatic duplicating unit of claim 2, wherein when none of network storage devices recorded in the duplication configuration file correspond to the file name or the file path recorded in the file variation message, the file duplicating subunit duplicates the file to a predetermined network storage device, via the network interface.

4. The network automatic duplicating unit of claim 1, wherein the network interface is an Ethernet interface.

5. The network automatic duplicating unit of claim 1, wherein the duplication configuration file is configured via a user interface installed in the information processing device.

6. The network automatic duplicating unit of claim 1, wherein the information processing device is an information product such as one of the hand-held/desktop/server computer, mobile phone, or PDA types.

7. An information processing device for automatically duplicating a file to at least one network storage device via a network, comprising:
an user interface allowing a user to configure and store at least one duplication rule as desired to a duplication configuration file;
an information processing unit coupled to the user interface, used to generate at least one file for recordation; and
a network automatic duplicating unit coupled to the information processing unit, used to check whether there is any file found for recordation, and according to the corresponding duplication rule recorded in the duplication configuration file to duplicate the file via a network interface to a specified network storage device as long as there is any file found for recordation.

8. The information processing device of claim 7, wherein the network automatic duplicating unit comprises:
a file checking subunit used to monitor variation of the file in the information processing device thereby determining whether there is any file found for recordation;
a message generating subunit used to create a corresponding file variation message when the file checking subunit determines that there is a file for recordation;
a message queuing subunit used to receive the file variation message thereby storing the file variation message into a message queue;
a message checking subunit used to determine whether there is any file variation message found in the message queue; and
a file duplicating subunit, used to duplicate the file to the network storage devices via the network interface.

9. The information processing device of claim 8, wherein the file variation message consists of at least a duplicated file path and a duplicated file name.

10. The information processing device of claim 9, wherein when none of network storage devices recorded in the duplication configuration file correspond to the file name or the file path recorded in the file variation message, the file duplicating subunit duplicates the file to the predetermined network storage device via the network interface.

11. The information processing device of claim 8, wherein the network interface is an Ethernet interface.

12. The information processing device of claim 7, wherein the information processing device further comprises a data storage unit, used to store the file therein.

13. A network automatic duplicating method suitable for automatically duplicating a file oriented from an information processing device to at least one network storage device, comprising:
checking whether there is any file generated by the information processing device for recordation;
creating a corresponding file variation message as long as there is a file found for recordation;
storing the file variation message into a message queue in sequence;
sequentially checking whether there is any file variation message found in the message queue; and
duplicating the file via a network interface to at least one network storage device, according to the file variation message and a predetermined duplication configuration file.

14. The network automatic duplicating method of claim 13, wherein the file variation message consists of at least a duplicated file path and a duplicated file name.

15. The network automatic duplicating method of claim 14, wherein when none of network storage devices recorded in the duplication configuration file correspond to the file name or the file path recorded in the file variation message, the file is duplicated to a predetermined network storage device via the network interface.

16. The network automatic duplicating method of claim 13, wherein the network interface is an Ethernet interface.

17. The network automatic duplicating method of claim 13, wherein the duplication configuration file is configured via an user interface installed in the information processing device.

18. The network automatic duplicating method of claim 13, further comprising a step of clearing the file variation message in the message queue.
